(19) United States
(12) Patent Application Publication
(10) Pub. No.: US 2015/0254233 A1
(43) Pub. Date: Sep. 10, 2015

(54) TEXT-BASED UNSUPERVISED LEARNING OF LANGUAGE MODELS

(71) Applicant: NICE-SYSTEMS LTD, Ra'anana (IL)

(72) Inventors: Shimrit ARTZI, Kfar Saba (IL); Maor NISSAN, Herzliya (IL); Ronny BRETTER, Kiriyat Motzkin (IL); Shai LlOR, Herzliya (IL)

(73) Assignee: NICE-SYSTEMS LTD, Ra'anana (IL)

(21) Appl. No.: 14/198,600

(22) Filed: Mar. 6, 2014

(51) Int. Cl. G06F 17/28

(52) U.S. Cl. CPC G06F 17/28

(57) ABSTRACT

A method for constructing a language model for a domain, comprising incorporating textual terms related to the domain in language models having relevance to the domain that are constructed from clusters of textual data collected from a variety of sources, thus generating an adapted language model adapted for the domain, wherein the textual data is collected from the variety or sources by a computerized apparatus connectable to the variety or sources and wherein the method is performed on an at least one computerized apparatus configured to perform the method.

### BACKGROUND

The present disclosure generally relates to language models, and more specifically to an adaptation of language models.

Language modeling such as used in speech processing is an established the art, and discussed in various articles as well as textbooks, for example:

Christopher D. Manning, Foundations of Statistical Natural Language Processing ISBN-13:978-0262133609), or ChengXiang Zhai, Statistical Language Models for Information Retrieval (ISBN-13:978-1601981868).

Speech decoding is also established in the art, for example, George Saon, Geoffrey Zweig, Brian Kingsbury, Lidia Mangu and Upendra Chaudhari, AN ARCHITECTURE FOR RAPID DECODING OF LARGE VOCABULARY CONVERSATIONAL SPEECH, IBM T. J. Watson Research Center, Yorktown Heights, N.Y., 10598, or U.S. Pat. Nos. 5,724,480 or 5,752,222.

### SUMMARY

A method for constructing a language model for a domain, comprising incorporating textual terms related to the domain in language models having relevance to the domain that are constructed from clusters of textual data collected from a variety of sources, thus generating an adapted language model adapted for the domain, wherein the textual data is collected from the variety or sources by a computerized apparatus connectable to the variety or sources and wherein the method is performed on an at least one computerized apparatus configured to perform the method.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

References to previously presented elements are implied without necessarily further citing the drawing or description in which they appear.

FIG. 1A schematically illustrates an apparatus for speech recognition;

FIG. 1B schematically illustrates a computerized apparatus for obtaining data from

FIG. 2 schematically illustrates a training of topic language models, according to exemplary embodiments of the disclosed subject matter;

FIG. 3 schematically illustrates an adaptation of topic language models, according to exemplary embodiments of the disclosed subject matter;

FIG. 4 schematically illustrates an evaluation of language models, according to exemplary embodiments of the disclosed subject matter;

FIG. 5 schematically illustrates an election of a language model, according to exemplary embodiments of the disclosed subject matter;

FIG. 6 schematically illustrates decoding of speech related to the domain, according to exemplary embodiments of the disclosed subject matter;

FIG. 7A concisely outlines adaptation of language models for a domain, according to exemplary embodiments of the disclosed subject matter; and

FIG. 7B outlines operations in adaptation of language models for a domain, according to exemplary embodiments of the disclosed subject matter.

### DETAILED DESCRIPTION

In the context of the present disclosure, without limiting and unless otherwise specified, referring to a ‘phrase’ implies one or more words and/or one or more sequences of words, wherein a word may be represented by a linguistic stem thereof.

Generally, in the context of the present disclosure, without limiting, a vocabulary denotes an assortment of terms as words and/or phrases and/or textual expressions.

Generally, in the context of the present disclosure, without limiting, a language model is any construct reflecting occurrences of words or phrases in a given vocabulary, so that, by employing the language model, words of phrases of and/or related to the vocabulary that is provided to the language model may be recognized, at least to a certain faithfulness.

Without limiting, a language model is a statistical language model where words and/or phrases and/or combinations thereof are assigned probability of occurrence by means of a probability distribution. A statistical language model is referred to herein, representing any language model such as known in the art.

In the context of the present disclosure, without limiting, a baseline language model or a basic language model imply a language model trained and/or constructed with a general and/or common vocabulary.

In the context of the present disclosure, without limiting, a topic language model implies a language model trained and/or constructed with a general vocabulary directed and/or oriented to a particular topic or subject matter.

In the context of the present disclosure, without limiting, referring to a domain implies a field of knowledge and/or a field of activity of a party. For example, a domain of business of a company.

In some embodiments, the domain refers to a certain context of speech such as audio recordings to a call center of an organization. Generally, without limiting, a domain encompasses a unique language terminology and unique joint words statistics which may be used for lowering the uncertainty in distinguishing between different sequences of words alternatives in decoding of a speech.

In the context of the present disclosure, without limiting, referring to data of a domain or a domain data implies phrases used and/or potentially used in a domain and/or context thereof. For example, ‘product’, ‘model’, ‘failure’ or ‘serial number’ in a domain of customer service for a product. Nevertheless, for brevity and streamlining, in referring to contents of a domain the data of a domain is implied. For example, receiving from a domain implies receiving from the data of the domain.

In the context of the present disclosure, without limiting, referring to a domain of interest or a target domain imply a particular domain and/or data thereof.

In the context of the present disclosure, without limiting, referring to a user implies a person operating and/or controlling an apparatus or a process.

In the context of the present disclosure, without limiting, a language model is based on a specific language, without precluding multiple languages.

The terms cited above denote also inflections and conjugates thereof

One technical problem dealt by the disclosed subject matter is automatically constructing a language model for a domain generally having small and/or insufficient amount of data for a reliable recognition of terms related to the domain.

One technical solution according to the disclosed subject matter is partitioning textual data obtained from a variety of sources, and based on the partitioned texts constructing language models, and consequently adapting the language models relevant to the domain by incorporating therein data of the domain.

Thus, the lack or deficiency of the data of the domain is automatically complemented or supplemented by the text related and/or pertaining to the domain, thereby providing a language model for a reliable recognition of terms related to the domain, at least potentially and/or to a certain extent.

A potential technical effect of the disclosed subject matter is a language model, operable in an apparatus for speech recognition such as known in the art, with high accuracy of recognition of terms in a speech related to a domain relative to a baseline language model and/or a language model constructed according only to the data of the domain.

Another potential technical effect of the disclosed subject matter is automatically adapting a language model, such as a baseline language model, independently of technical personnel such as of a supplier of the language model. For example, a party such as a customer of an organization may automatically adapt and/or update a language model of the party to a domain of the party without intervention of personnel of the organization.

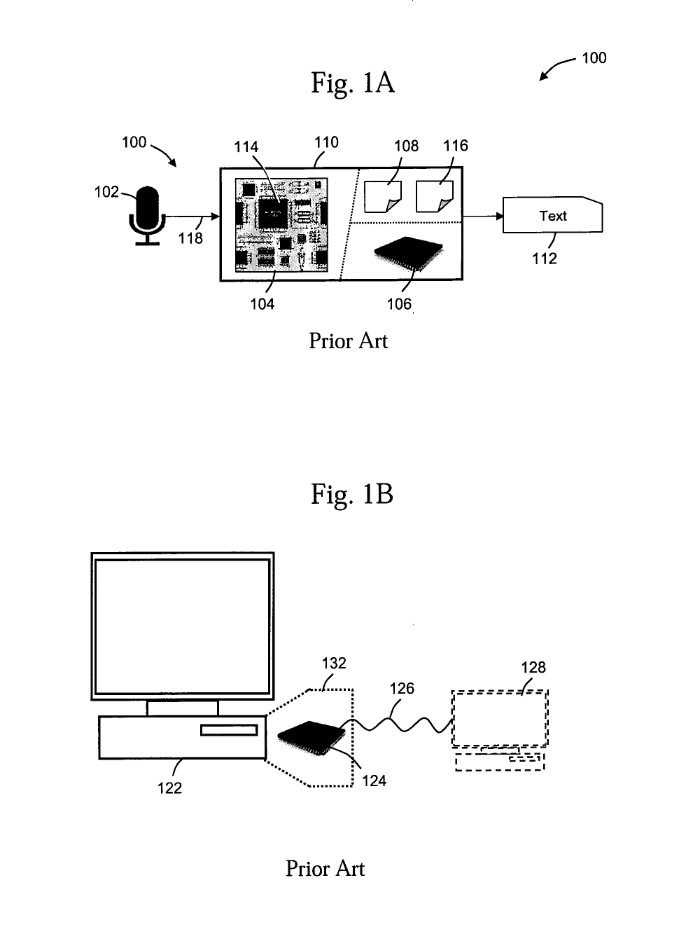

FIG. 1A schematically illustrates an apparatus 100 for speech recognition, as also known in the art.

The apparatus comprises an audio source of speech, represented schematically as a microphone 102 that generates an audio signal depicted schematically as an arrow 118. The audio signal is provided to a processing device 110, referred to also a decoder, which converts the audio signal into a sequence or stream of textual items as indicated with symbol 112.

Generally, processing device 110 comprises an electronic circuitry 104 which comprises an at least one processor such as a processor 114, an operational software represented as a program 108 and a speech recognition component represented as a component 116.

Generally, without limiting, component 116 comprises three parts or modules (not shown) as (1) a language model which models the probability distribution over sequences of words or phrases, (2) a phonetic dictionary which maps words to sequences of elementary speech fragments, and (3) an acoustic model which maps probabilistically the speech fragments to acoustic features.

In some embodiments, program 108 and/or component 116 and/or parts thereof are implemented in software and/or one or more firmware devices such as represented by an electronic device 106 and/or any suitable electronic circuitry.

The audio signal may be a digital signal, such as VoIP, or an analog signal such as from a conventional telephone. In the latter case, an analog-to-digital converter (not shown) comprised in and/or linked to processing device 110 such as by an I/O port is used to convert the analog signal to a digital one.

Thus, processor 114, optionally controlled by program 108, employs the language model to recognize phrases expressed in the audio signal and generates textual elements such as by methods or techniques known in the art and/or variations or combinations thereof.

FIG. 1B schematically illustrates a computerized apparatus 122 for obtaining data from a source.

Computerized apparatus 122, illustrated by way of example as a personal computer, comprises a communication device 124, illustrated as an integrated electronic circuit in an expanded view 132 of computerized apparatus 122.

By employing of communication device 124, computerized apparatus 122 is capable to communicate with another device, represented as a server 128, as illustrated by a communication channel 126 which represents, optionally, a series of communication links.

A general non-limiting presentation of practicing the present disclosure is given below, outlining exemplary practice of embodiments of the present disclosure and providing a constructive basis for elaboration thereof and/or variant embodiments.

According to some embodiments of the disclosed subject matter, in order to construct a language model adapted to a domain two suits or sets of textual data or texts are required. One suite comprises data of the domain obtained from the domain, referred to also as a ‘adaptive corpus’, and the other suite comprises data obtained from various sources that do not necessarily pertain to the domain though may comprise phrases related to the domain, referred to also as a ‘training corpus’.

The training corpus is processed to obtain therefrom clusters and/or partitions characterized by categories and/or topics. The clusters are used to construct language models, denoted also as topic models. In some embodiments, in order to converge or focus on the domain, topic models relevant or related to the domain, such as by the topics and/or data of the language models such as by unique terms, are selected for further operations.

Vocabulary extracted from the adaptive corpus is incorporated in and/or with the selected topic language models, thereby providing a language model, denoted also as an adapted language model, which is supplemented with textual elements related to the domain so that recognition fidelity of terms pertaining to the domain is enhanced, at least potentially.

For brevity and clarity, categories and/or topics are collectively referred to also as topics, and clusters and/or partitions are collectively referred to as clusters.

The adapted language model, however, may not function substantially better than a given non-adapted language model, such as a baseline language model, in recognition of terms in a speech related to the domain.

Therefore, in some embodiments, the recognition performance between the adapted language model and the non-adapted language model is evaluated to determine whether the adapted language model is substantially more suitable to recognize terms in a test speech related to or associated with the domain.

In case the performance of the adapted language model is not substantially better than the non-adapted language model than either the non-adapted language model is elected for speech recognition for the domain, or, alternatively, the training corpus is increased or replaced and further topic language models are constructed for further adaptation.

It is noted that relation and/or relevancy and/or similarity to the domain may be judged and/or determined based on representative data of the domain and/or adaptive corpus such as keywords obtained from the adaptive corpus.

In some embodiments, the training corpus is clustered according to topics by methods of the art such as k-means, as for example, in The k-means algorithm (http://www.cs.uvm.edu/˜xwu/kdd/Slides/Kmeans-ICDM06.pdf) or Kardi Teknomo, K-Means Clustering Tutorial (http:\\people.revoledu.com\kardi\tutorial\kMean\).

As a non-limiting example, key-phrases are extracted from the texts of the training corpus, and based on the key-phrases K clusters are obtained where K is predefined or determined. K centroids are defined as the K closest vectors to the global centroids of the entire data set, letting the data alone to steer the centroids apart where by averaging all vectors effect outliers are offset. In subsequent iterations each vector is assigned the closest centroid and then the centroids are recomputed.

The ‘distance’ between a text and a cluster is defined as the similarity of the text with respect of the cluster. For example, the cosine distance is used to evaluate a similarity measure with TF-IDF term weights to determine the relevance of a text to cluster. The TF-IDF (term frequency—inverted document frequency) score of a term is the term frequency divided by the logarithm of the number of texts in the cluster in which the term occurs.

The TF-IDF method is disclosed, for example, in Stephen Robertson, Understanding Inverse Document Frequency: On theoretical arguments for IDF, Microsoft Research, 7 JJ Thomson Avenue, Cambridge CB3 0FB, UK, (and City University, London, UK), or in Juan Ramos, Using TF-IDF to Determine Word Relevance in Document Queries, Department of Computer Science, Rutgers University, 23515 BPO Way, Piscataway, N.J., 08855.

Exemplary clustering of texts is presented in Table-1 below.

TABLE 1

| Column-I | | Column-II | | Column-III | |
|---|---|---|---|---|---|
| Term | Score | Term | Score | Term | Score |
| Try | 0.55 | Card | 1.27 | Local access | 1.1 |
| Technical support | 0.53 | Credit card | 1.13 | Internet | 0.8 |
| Connect | 0.52 | Debit | 0.56 | Long distance | 0.73 |
| Option | 0.48 | Expiration | 0.55 | Internet service | 0.6 |
| | | date | | | |
| Trouble | 0.47 | Bill | 0.51 | Area | 0.59 |
| Unit | 0.43 | Payment | 0.50 | Internet access | 0.56 |
| Problem | 0.39 | Update | 0.47 | Service provider | 0.54 |
| Do not work | 0.39 | Account | 0.41 | Local number | 0.5 |

Each column includes terms with respective scores, such as terms weights as determined with the TF-IDF method or terms probability measure.

It is clearly evident that each column includes terms which collectively and/or by the interrelations therebetween relate to or imply a distinct topic. Thus, for example, the topics of column-I to column-III are, respectively, technical support, financial accounts and internet communications.

The clusters are intended for adaptation to a language model directed and/or tuned for the domain. Therefore, only clusters of topics that do relate in various dergees to the domain are considered and/or chosen for adaptation.

For example, in case the domain or a party of a domain concerns finance activities, then the terms in column-II are used to construct a domain adapted language model with a larger weight relative to the terms in the rest of the columns that are used with lower weights which might approach zero as they are less related to the domain data, and thus negligibly contributing to the domain adapted language model at least with respect to the terms in column-II.

It is noted that, effectively, the clustering process does not necessarily require intervention of a person. Thus, in some embodiments, the clustering is performed automatically without supervision by a person.

In some embodiments, in order to accelerate the clustering process some operations are precede the clustering.

In one operation words in the training corpus are extracted and normalized by conversion to the grammatical stems thereof, such as by a lexicon and/or a dictionary. For example, ‘went’ is converted to ‘go’ and ‘looking’ to ‘look’. Thus, the contents are simplified while not affecting, at least substantially, the meaning of the words, and evaluation of similarity of contents is more efficient since words and inflections and conjugations thereof now have common denominators.

In another operation, which optionally precedes the stemming operation, words of phrases in the training corpus are grammatically analyzed and tagged according to parts of speech thereof, for example, Adjective-Noun, Noun-Verb-Noun.

In some embodiments, the stems, optionally with the tagging, are stored in indexed data storage such as a database, for efficient searching of key phrases and topics, enabling to retrieve large quantity of texts with high confidence of relevance relative to non-structured and/or non-index forms.

It is noted that, at least in some embodiments, the original training corpus is preserved for possible further operations.

It is also noted that the normalization and tagging processes do not necessarily require intervention of a person. Thus, in some embodiments, the normalization and tagging are performed automatically without supervision by a person.

The training corpus is constructed by collecting from various sources textual documents and/or audio transcripts such as of telephonic interaction and/or or other textual data such as emails or chats.

The training corpus is clustered as described above, optionally, based on normalization and tagging as described above. Based on the texts in the clusters and topics inferred therefrom, different topic language models are constructed and/or trained.

The topic language models are generated such as known in the art, for example, as in X Liu, M. J. F. Gales & P. C. Woodland, USE OF CONTEXTS IN LANGUAGE MODEL INTERPOLATION AND ADAPTATION, Cambridge University Engineering Department, Trumpington Street, Cambridge. CB2 1PZ England (http://www.sciencedirect.com/science/article/pii/S0885230812000459), denoted also as Ref-1.

Thus, the topic language models are generated as N-gram language model with the simplifying assumption that the probability of a word depends only on the preceding N-1 words, as in formula (1) below.

P(w/h)≈P(w/(w₁w₂ . . . wₙ₋₁)) (1)

Where P is a probability, w is a word, h is the history of previous words, and wₓ is the x^{th} word in a previous sequence of N words.

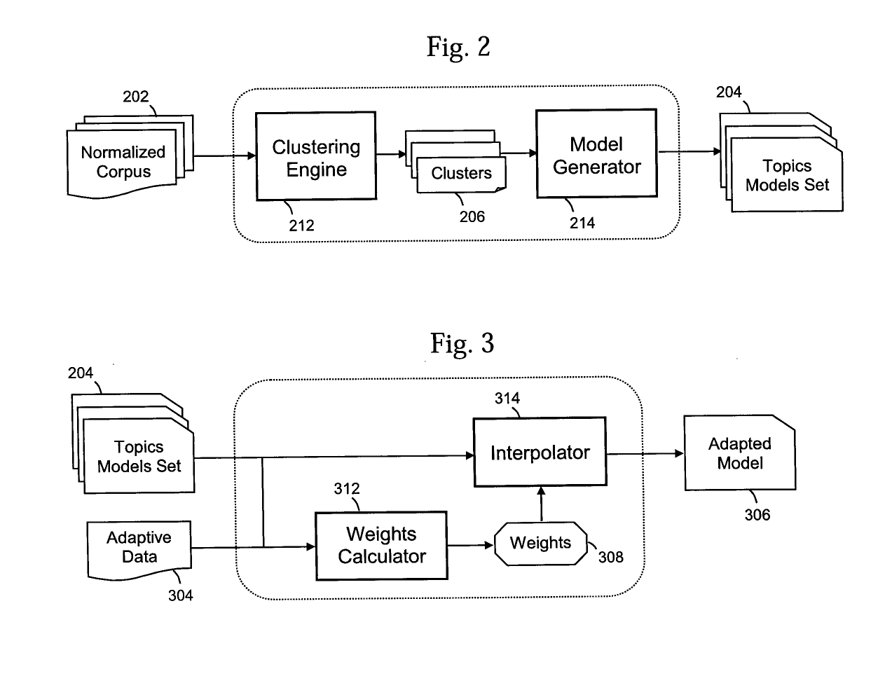

FIG. 2 schematically illustrates a training of topic language models, according to exemplary embodiments of the disclosed subject matte and based on the descriptions above.

The training corpus after normalization, referred to also as a normalized training corpus and denoted as a normalized corpus 202, is provided to a clustering process, denoted as a clustering engine 212. Based on normalized corpus 202 clustering engine 212 constructs clusters akin to the texts in the columns of Table-1 above, the clusters denoted as clusters 206.

Clusters 206 are forwarded to a language model constructing or training process, denoted as a model generator 214, which generates a set of topic language model models, denoted as topics models set 204, respective to clusters 206 and topics thereof.

It is noted that, effectively, the training process does not necessarily require intervention of a person. Thus, in some embodiments, the training is performed automatically without supervision by a person.

The adaptive corpus is obtained as textual data of and/or related to the domain from sources such as Web site of the domain and/or other sources such as publications and/or social networking or any suitable source such as transcripts of telephonic interactions.

In some embodiments, the textual data thus obtained is analyzed and/or processed to yield text data that represents the domain and/or is relevant to the domain, denoted also as a ‘seed’. For example, the seed comprises terms that are most frequent and/or unique in the adaptive corpus.

In some embodiments, in caser the adaptive corpus is determined to be small, such as by the number of distinctive stems of terms relative to a common general vocabulary, then the adaptive corpus is used and/or considered as the seed.

Thus, for clarity and brevity, the textual data pertaining to the domain decided for adaptation of the topic language models, either the adaptive corpus or the seed, is referred to collectively as adaptive data.

The topic language models that pertain to the domain and/or the topic language models with topics that are most similar to the domain are adapted to the domain by incorporating terms of the adaptive data. In some embodiments, the incorporation is by interpolation where the weights such as probabilities of terms in the topic language models are modified to include terms from the adaptive data with correspondingly assigned weights. In some embodiments, the incorporation of terms in a language model is as known in the art, for example, as in Bo-June (Paul) Hsu, GENERALIZED LINEAR INTERPOLATION OF LANGUAGE MODELS, MIT Computer Science and Artificial Intelligence Laboratory, 32 Vassar Street, Cambridge, Mass. 02139, USA, or as in Ref-1 cited above.

Thus, in some embodiments, the interpolation is based on evaluating perplexities of the texts in the topic language model and the adaptive data, where perplexities measure the predictability of each of the topic language models with respect to the adaptive data, that is, with respect to the domain.

In some embodiments, a linear interpolation is used according to formula (2) below:

Pᵢₙₜₑᵣₚ(wᵢ/h)=ΣλᵢPᵢ(wᵢ/h) (2)

Where Pᵢ the probability of a word wᵢ with respect to preceding sequence of words h, λᵢ is the respective weight and Pᵢₙₜₑᵣₚ is the interpolated probability of word wᵢ with respect to preceding sequence, with the condition as in formula (3) below:

Σλᵢ=1 (3)

FIG. 3 schematically illustrates an adaptation of topic language models, according to exemplary embodiments of the disclosed subject matter.

Topic models set 204 and the adaptive data or seed thereof, denoted as adaptive data 304, are provided to a process for weights calculation, denoted as a weights calculator 312, which generates a set of weights, such as a set of λᵢ, denoted as weights 308.

Topic models set 204 and weights 308 are provided to a process that carries out the interpolation, denoted as an interpolator 314, which interpolates terms of topic models set 204 and adaptive data 304 to form a language model adapted for the domain, denoted as adapted model 306.

It is noted that, effectively, the adaptation process does not necessarily require intervention of a person. Thus, in some embodiments, the adaptation is performed automatically without supervision by a person.

Having formed adapted model 306, the adaptation is principally concluded. Whoever, adapted model 306 was formed open-ended in the sense that it is not certain whether the adapted language model is indeed better than a non-adapted language model at hand.

The non-adapted language model may be a previously adapted language model or a baseline language model, collectively referred to also for brevity as an original language model.

Therefore, the performance of adapted model 306 is evaluated to check if it has an advantage in recognizing terms in a speech related to the domain relative to the baseline language model.

In some embodiments, the evaluation as described below is unsupervised by a person, for example, according to unsupervised testing scheme in Strope, B., Beeferman, D., Gruenstein, A., & Lei, X (2011), Unsupervised Testing Strategies for ASR, INTERSPEECH (pp. 1685-1688).

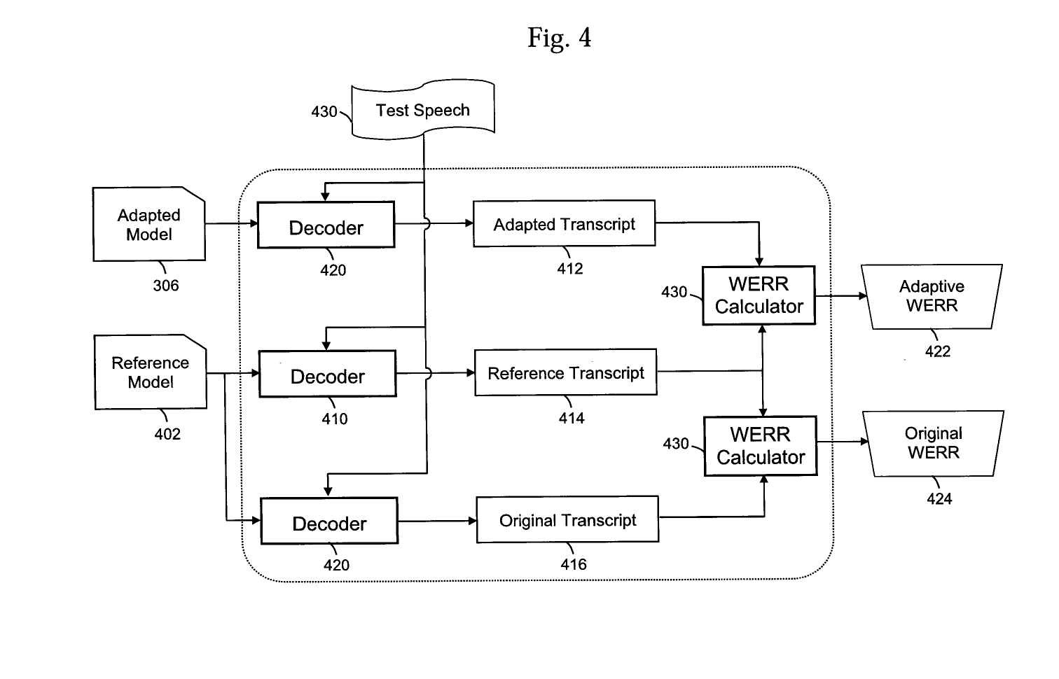

FIG. 4 schematically illustrates an evaluation of language models, according to exemplary embodiments of the disclosed subject matter.

A speech decoder, denoted as a decoder 410, is provided with test audio data, denoted as a test speech 430, which comprises audio signals such as recordings and/or synthesized speech.

Decoder 410 is provided with a reference language model, denoted as a reference model 402, which is language model beforehand constructed and tuned for vocabulary of the domain, and decoder 410 decodes test speech 430 by the provided language models to texts as a reference transcript 414.

Decoder 420 is provided with (i) adapted language model 306 and (ii) a reference language model, denoted as a reference model 402, and decoder 420 decodes test speech 430 by the provided language models to texts denoted as (i) an adapted transcript 412 and (ii) an original transcript 416, respectively.

A process that evaluates the word error rate, or WERR, between two provided transcripts, denoted as a WERR calculator 430, is used to generate the word error rate of one transcript with respect to the other transcript.

Thus, adapted transcript 412 and reference transcript 414 are fed to WERR calculator 430 and the word error rate of adapted transcript 412 with respect to reference transcript 414 is generated as a value, denoted as adaptive WERR 422.

Likewise, original transcript 416 and reference transcript 414 are fed to WERR calculator 430 and the word error rate of original transcript 416 with respect to reference transcript 414 is generated as a value, denoted as original WERR 424.

In some embodiments, decoder 410 operates with a ‘strong’ acoustic model and in some embodiments, decoder 420 operates with a ‘weak’ acoustic model, where a strong acoustic model comprises larger amount of acoustic features than a weak acoustic model.

It is noted for intelligibility and clarity decoder 420 is illustrated two times, yet the illustrated decoders are either the same decoder or equivalent. Likewise, WERR calculator 430 is illustrated two times, yet the illustrated calculators are either the same or equivalent ones.

It is also noted that, in some embodiments, reference transcript 414 is prepared beforehand rather than decoded along with adapted model 306 and original model 404.

The difference between adaptive WERR 422 and original WERR 424 is derived, as in formula (4) below.

WERR_{diff}=WERR_{adoated}−WERR_{original} (4)

Where WERR_{adoated} stands for adaptive WERR 422, WERR_{original} for original WERR 424 and WERR_{diff} is the difference.

In case WERR_{diff} is smaller than 0, or optionally smaller than a sufficiently negligible threshold, it is understood that adapted model 306 is less error prone and more reliable in recognition of terms related to the domain then original model 404, and thus adapted model 306 is elected for subsequent utilization of speech related to the domain. In other words, the adaptation was successful at least for a certain extent.

On the other hand, in case WERR_{diff} is larger than 0, or optionally larger than a sufficiently negligible threshold, the adaptation effectively failed and original model 404 is elected for subsequent utilization of speech related to the domain.

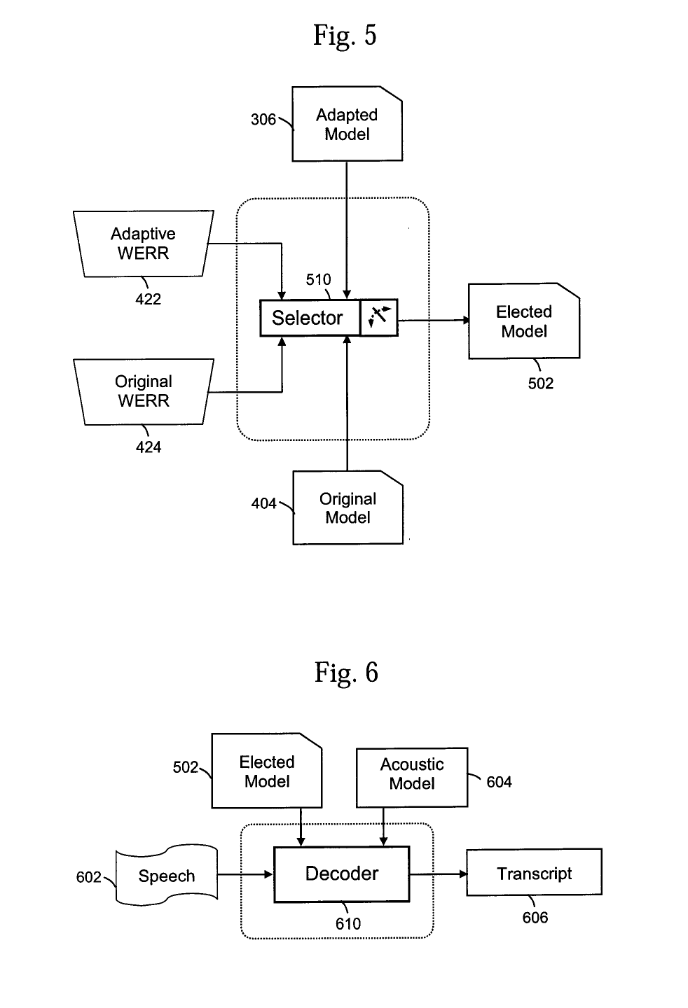

FIG. 5 schematically illustrates an election of a language model, according to exemplary embodiments of the disclosed subject matter.

Adaptive WERR 422 and original WERR 424 are provided to a calculator process, denoted as a selector 510, which decides, such as according to formula (4) and respective description above, which of the provided adapted model 306 and original model 404 is elected for further use. Thus, selector 510 provides the appropriate language model, denoted as an elected model 520.

It is noted that, in some embodiments, adapted model 306 and original model 404 are not actually provided to selector 510 but, rather, referenced thereto, and, accordingly, in some embodiments, selector 510 provides a reference to or an indication to elected model 520.

In some embodiments, in case the adaptation effectively failed, other or further training data and/or data of the domain may be collected and used for adaptation as described above, potentially improving the adaptation over the original language model.

It is noted that, at least in some embodiments, the evaluation of the language models and selection of the elected model are carried out automatically with no supervision and/or intervention of a person.

The elected language model and an acoustic model which maps probabilistically the speech fragments to acoustic features are used for recognition of speech related to the domain. Optionally, a phonetic dictionary which maps words to sequences of elementary speech fragments is also trained and incorporated in domain system.

FIG. 6 schematically illustrates decoding of speech related to the domain, according to exemplary embodiments of the disclosed subject matter.

Elected model 520 and the acoustic model, denoted as an acoustic model 604, as well a speech related to the domain, denoted as a speech 602, are provided to decoder 610 which, in some embodiments, is the same as or a variant of decoded 410.

Based on elected model 520 acoustic model 604 and optionally the phonetic model (not shown), decoder 610 decodes speech 602 to text, denoted as a transcript 606.

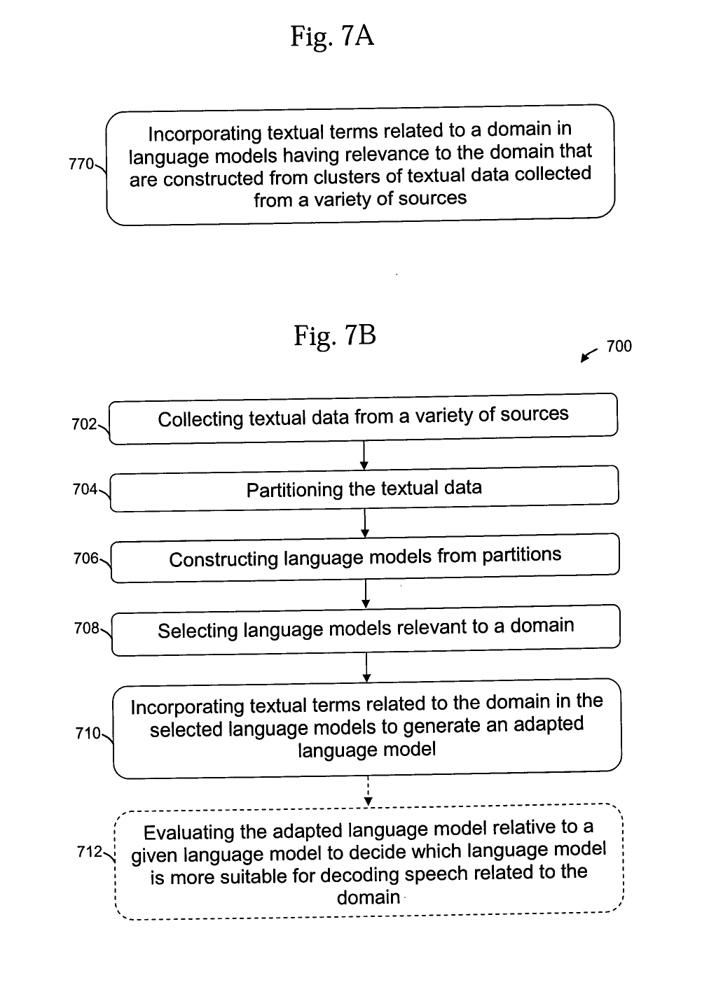

FIG. 7A concisely outlines adaptation of language models for a domain, according to exemplary embodiments of the disclosed subject matter.

In operation 770 a plurality of language model are constructed by collecting textual data from a variety of sources, and the textual data is consequently partitioned to construct the plurality of language models, wherein language models that are relevant to a domain, such as by inferred topics, are used to incorporate therein textual terms related to the domain, thereby generating an adapted language model adapted for the domain. The incorporation of textual terms in the language models is carried out, for example, by interpolation of the textual terms in the textual data of the language models.

FIG. 7B outlines operations 700 in adaptation of language models for a domain, elaborating operation 770, according to exemplary embodiments of the disclosed subject matter.

In operation 702 textual data such as textual documents and/or audio transcripts, such as of telephonic interactions, and/or or other textual data such as emails or chats is collected.

In operation 704 the textual data is partitioned, such as by k-means algorithm, to form a plurality of clusters having respective topics such as inferred from the data of the clusters.

In operation 706 the textual data of the plurality of the partitions are used construct a plurality of corresponding language models such as by methods known in the art. For example, according to frequency of terms and/or combinations thereof.

In operation 708 constructed language models determined as relevant to a domain, such as by topics of the corresponding partitions, are selected.

In operation 710 textual terms related to the domain, such as terms acquired from data of the domain thus representing the domain, are incorporated in the selected language models to generate or construct an adapted language model adapted for the domain. For example, the textual terms are interpolated with textual data of the selected language models according to determined weights.

In operation 712, optionally, the adapted language model is evaluated with regard to recognition of speech related to the domain against a given language model, thereby deciding which language model is more suitable for decoding of speech pertaining to the domain. For example, a test speech is decoded and transcribe by each of the models, and according to the error rate with respect to a reference transcript of the speech the less error prone language model is elected.

Optionally, two or more operations of operations 700 may be combined, for example, operation 708 and operation 710.

It is noted that the processes and/or operations described above may be implemented and carried out by a computerized apparatus such as a computer and/or by a firmware and/or electronic circuits and/or combination thereof.

There is thus provided according to the present disclosure a method for constructing a language model for a domain, comprising incorporating textual terms related to the domain in language models having relevance to the domain that are constructed from clusters of textual data collected from a variety of sources, thus generating an adapted language model adapted for the domain, wherein the textual data is collected from the variety or sources by a computerized apparatus connectable to the variety or sources and wherein the method is performed on an at least one computerized apparatus configured to perform the method.

In some embodiments, the domain is of small amount of textual terms insufficient for constructing a language model for a sufficiently reliable recognition of terms in a speech related to the domain.

In some embodiments, the textual terms related to the domain are incorporated in the language models by interpolation according to determined weights.

In some embodiments, the textual data is partitioned according to an algorithm of the art based on phrases extracted from the textual data and similarity of the textual data with respect of the clusters.

In some embodiments, the algorithm of the art is according to a k-means algorithm.

In some embodiments, the textual data is converted to indexed grammatical stems thereof, thereby facilitating expedient acquiring of phrases relative to acquisition from the textual data.

In some embodiments, the method further comprises evaluating the adapted language model with respect to a provided language model to determine which of the cited language models is more suitable for decoding speech related to the domain.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for constructing a language model for a domain, comprising:
incorporating textual terms related to the domain in language models having relevance to the domain that are constructed from clusters of textual data collected from a variety of sources, thus generating an adapted language model adapted for the domain,
wherein the textual data is collected from the variety or sources by a computerized apparatus connectable to the variety or sources and wherein the method is performed on an at least one computerized apparatus configured to perform the method.

2. The method according to claim 1, wherein the domain is of small amount of textual terms insufficient for constructing a language model for a sufficiently reliable recognition of terms in a speech related to the domain.

3. The method according to claim 1, wherein the textual terms related to the domain are incorporated in the language models by interpolation according to determined weights.

4. The method according to claim 1, wherein the textual data is partitioned according to an algorithm of the art based on phrases extracted from the textual data and similarity of the textual data with respect of the clusters.

5. The method according to claim 4, wherein the algorithms of the art is according to a k-means algorithm.

6. The method according to claim 1, wherein the textual data is converted to indexed grammatical stems thereof, thereby facilitating expedient acquiring of phrases relative to acquisition from the textual data.

7. The method according to claim 1, wherein the method further comprises evaluating the adapted language model with respect to a provided language model to determine which of the cited language models is more suitable for decoding speech related to the domain.
